(19) United States
(12) Patent Application Publication
(10) Pub. No.: US 2023/0219664 A1
(43) Pub. Date: Jul. 13, 2023

(54) HIGH-TECH SURFBOARD AND ITS OVERSIGHT (OVER-SEA-SIGHT) INTERCONNECTED NETWORK

(71) Applicant: Yossi ABUDY

(72) Inventor: Yossi ABUDY

(21) Appl. No.: 18/004,305

(22) PCT Filed: Mar. 15, 2021
(86) PCT No.: PCT/IL2021/050278

§ 371 Date: Jan. 5, 2023

(30) Foreign Application Priority Data
Mar. 15, 2020 (IL) 273310

(51) Int. Cl. B63B 79/15; B63B 32/40; B63B 49/00; B63B 32/70; G08B 21/04

(52) U.S. Cl. CPC B63B 79/15; B63B 32/40; B63B 32/70; B63B 49/00; G08B 21/043; B63B 2213/02

(57) ABSTRACT

A water activity board is described, comprising: a. a plurality of sensors, b. a data unit interconnected to the sensors. c. a communication unit interconnected to the data unit. wherein the communication unit is configured to communicate to a cloud-based database. In some embodiments the sensors are selected from a group consisting of Environmental sensors, sea platform sensors and User sensors.

### FIELD OF THE INVENTION

The invention is in the field of sea environment of safety and security. The technology herein described pertains to products for saving lives during water activity emergency under hazardous conditions.

### BACKGROUND OF THE INVENTION

There are a multiple of risks in the open sea/ocean and water conditions can change rapidly and unexpectedly to a rough sea duo to a stormy weather and climate system shifting:

The Sea could be dangerous: such as hidden beaches, protected by natural or artificial bays, marinas and breakwaters, obstacles, iceberg, buoys and other water born objects resulting from water activities and ocean-based industries (such as fishing and industry).

Marine Life habitats forms: mammals and dangerous marine animals, large and small:

Sharks, Seals, Sea Snakes, Jellyfish and Stingrays, Sea urchin, whales etc.

Waves: Wipeouts by waves can be dangerous and incredibly powerful. Some are powerful enough to break bones and cause injuries.

Drowning: Getting trapped on the reef, being separated from your board or any other relatively light sea platform and being unable to return safely to shore.

Riptides: exhausting currents that can sweep the user out to sea.

If it’s a sandy bottom it will feel like concrete if a wave pounds you down upon it.

If it is a rock reef it will be much more jagged and likely to cause more serious injuries.

If it is coral with multiple sharp edges, you are in real trouble. First, it will cut you like a razor blade, then it will leave tiny pieces behind to infect you for months after.

Most users don’t have the time or the means to get to safety or have the means to send a distress call for help when an emergency happens. In many cases assistance/help is far away and has a hard time finding the person in distress.

There exists a long-felt need for a novel break- through and high-tech search and rescue system for safety precaution, in order to improve the survivability of the user in times of trouble at hostile sea environment.

### SUMMARY

It is the object of the present invention to present a water activity board, comprising:
a. a plurality of sensors.
b. a data unit interconnected to the sensors.
c. a communication unit interconnected to the data unit.
wherein the communication unit is configured to communicate to a cloud-based database.

It is another object of the current invention to disclose the board as defined in any of the above, wherein the sensors are selected from a group consisting of Environmental sensors, sea platform sensors and User sensors

It is another object of the current invention to disclose the board as defined in any of the above, wherein the environmental sensors are selected from a group consisting of water sensors, sonar, meteorological sensors and visual/optical detector.

It is another object of the current invention to disclose the board as defined in any of the above, wherein the water sensors are selected from a group consisting of sensor for the detection of temperature, chemicals, pH, toxins, salinity,

It is another object of the current invention to disclose the board as defined in any of the above, wherein the water sensors are selected from a group consisting of sensor for the detection of wind speed, wind direction, atmospheric temperature, atmospheric humidity and atmospheric pressure.

It is another object of the current invention to disclose the board as defined in any of the above, wherein the visual/optical sensors are selected from a group consisting of cameras, UV spectrophotometer, IR spectrophotometer

It is another object of the current invention to disclose the board as defined in any of the above, wherein the board sensors are selected from a group consisting of global positioning system (GPS), satellite tracking system and movement/motion sensor.

It is another object of the current invention to disclose the board as defined in any of the above, wherein the user sensors are selected from a group consisting of Pressure sensor, heartbeat sensor, heat sensor and blood pressure sensor.

It is another object of the current invention to disclose the board as defined in any of the above, wherein the user sensors are configured as part of the body, floor, rig and/or handle of the board. It is another object of the current invention to disclose the board as defined in any of the above, wherein the user sensors are connected to the user by a hand, arm, wrist or ankle band.

It is another object of the current invention to disclose the board as defined in any of the above, wherein the user sensors are configured to detection the position, actions and/or status of the user.

It is another object of the current invention to disclose the board as defined in any of the above, wherein the sensors are configured to transmit generated data to the data unit.

It is another object of the current invention to disclose the board as defined in any of the above, wherein the data unit is configured to store and/or log data received from the sensors.

It is another object of the current invention to disclose the board as defined in any of the above, wherein the data unit comprises a unit characterized as transitory memory, computer-readable memory

It is another object of the current invention to disclose the board as defined in any of the above, additionally comprising a processor, interconnected to the data unit and the communication unit.

It is another object of the current invention to disclose the board as defined in any of the above, wherein the processor is configured to perform at least one action selected from:
a. to receive data from the sensors;
b. to receive data from the data loggers;
c. to transmit data via the communication unit; and
d. to control the operation of the sensors.

It is another object of the current invention to disclose the board as defined in any of the above, wherein the communication unit is configured to transmit data from the data unit or the processor.

It is another object of the current invention to disclose the board as defined in any of the above, wherein the communication unit is configured to communicate using at least one technologies selected from a consisting of radio and electromagnetic waves.

It is another object of the current invention to disclose the board as defined in any of the above, wherein the communication unit is configured to communicate used a protocol selected from a group consisting of Bluetooth, wireless, cellular,

It is another object of the current invention to disclose the board as defined in any of the above, wherein the components are interconnected by technologies selected from a group consisting of wired and wireless technologies.

It is another object of the current invention to disclose the board as defined in any of the above, wherein the components are configured to create:
d. a wired or wireless local area network (WLAN);
e. a wired or wireless personal area network (WPAN);
f. a low-power wide-area network (LPWAN);
g. a wireless sensor network (WSN).

It is another object of the current invention to disclose the board as defined in any of the above, wherein the in particular sport board is configured as a surf board, a wind-surf board, paddleboard, standup paddleboard or a kite-surfing board.

It is another object of the current invention to disclose the board as defined in any of the above, additionally comprising a safety system, selected from a group consisting of means for an alert and a first aid kit.

It is another object of the current invention to disclose the board as defined in any of the above, wherein the means for alert is selected from a group consisting of physical means and electronic means.

It is another object of the current invention to disclose the board as defined in any of the above, wherein the physical means for alert is selected from a group consisting of noise, sound and light.

It is another object of the current invention to disclose the board as defined in any of the above, wherein the electronic means for alert is based on an electromagnetic technology selected from a group consisting a cellular signal, a Bluetooth beacon.

It is another object of the current invention to disclose the board as defined in any of the above, wherein the electronic means is configured to generate/emit a signal encoding user data, the data selected from a group consisting of user position, user status.

It is another object of the current invention to disclose the board as defined in any of the above, additionally comprising a power source, wherein the source is characterized as a battery.

It is another object of the current invention to disclose the board as defined in any of the above, wherein the battery is a rechargeable.

It is another object of the current invention to disclose the board as defined in any of the above, additionally comprising a charging unit configured to charge the battery from a source selected from a group consisting of wind power, water power, solar energy and user actions.

It is another object of the current invention to disclose the board as defined in any of the above, wherein the battery is replaceable.

It is another object of the current invention to disclose the board as defined in any of the above, additionally comprising a display, the display configured to present the data from the sensors.

It is another object of the current invention to disclose the board as defined in any of the above, wherein the components are characterized as waterproof, IP65 or higher.

An autonomous communication system, comprising:
a. the board system as defined in any of the above; and
b. a cloud-based data base (CBDB);
wherein the communication system is configured to communicate with the cloud-based data base.

It is another object of the current invention to disclose the communication system as defined in any of the above, wherein the CBDB is characterized by at least one of the following:
a. configured to receive data from the communication system;
b. configured to store data from the communication systems;
c. configured to analyze the data;
d. configured to present the data from the communication system;
e. configured to present analysis from the data base.

It is another object of the current invention to disclose the communication system as defined in any of the above, wherein the CBDB is configured to generate an alert regarding emergencies, hazards or other safety issues.

It is another object of the current invention to disclose the communication system as defined in any of the above, additionally comprising a maned or unmanned vehicle.

It is another object of the current invention to disclose the communication system as defined in any of the above, wherein the vehicle is a drone.

A method of participating is water sports, comprising steps of:
a. obtaining the board as described above;
b. activating the systems of the board; and
c. using board;
wherein the board comprises sensors, configured to collect data characterized as environmental data, board data or user data.

A method of evaluating the safety of a user, comprising steps of:
a. obtaining the board as described above;
b. activating the systems of the board;
c. using the board;
d. analyzing the data of the sensors; and
e. presenting data and analysis of the data;
wherein the data is collected from at least one sensor on the board.

It is another object of the current invention to disclose the method as defined in any of the above, additionally comprising a step of transferring the data to a cloud based data base.

It is another object of the current invention to disclose the method as defined in any of the above, additionally comprising a step of identifying hazardous or unsafe conditions.

It is another object of the current invention to disclose the method as defined in any of the above, additionally comprises a step of identifying changes in the status of the user.

It is another object of the current invention to disclose the method as defined in any of the above, additionally comprising a step of generating an emergency alert.

### BRIEF DESCRIPTION OF THE DRAWINGS

The accompanying drawings, which are included to provide a further understanding of the invention as a One example in one platform and one selected variant among many other options that exist and which can be practically implemented and can be Applicable and realizable in practice and are incorporated in and constitute a part of this specification and illustrates the embodiments of the invention and together with the description serve to explain the principles of the invention wherein:

FIG. 1 - present a schematic representation of the system of the present invention

FIG. 2 - presents an example of the present invention

FIG. 3 - presents an example of the present invention

FIG. 4 - presents a block diagram of the High Tech Surf Board (HTSB) as a one example of many others optional arrays and structures that can be applied in the present invention

### DETAILED DESCRIPTION OF THE INVENTION

The following description is provided, alongside all chapters of the present invention, as to enable any person skilled in the art to make use of the invention and sets forth the best modes, contemplated by the inventor of carrying out this invention.

Various modifications, however, are adapted to remain apparent to those skilled in the art, since the generic principles of the present invention have been defined specifically to provide compositions and methods.

In the present invention, the term S.O.S.ea refers to the high-tech surfboard or any other relatively light sea platform and its Oversight (Over-Sea-Sight) interconnected network based system of the present invention.

In the present invention, the term InReach refers to an autonomous, modular communication systems.

An autonomous and structurally integrated built in and inReach communication system on any other relatively light sea platform in general and in particular, in any kind of board. The system combines advanced technologies, monitoring systems remotely controlled and produced as an ancillary product, application and component features database: both: digital and/or analog raw data as one ,media: voice: as a distress call from cellular phone and/or video: visualization on a web network, real time video conference and live pictures to the user or any other optional users on the real-time computing (RTC) or net grid, in collaborative information Cloud defined herein as an OVERSIGHT (Over-Sea-Sight) network which can be projected to the user by the company sight user account subscription.

Purpose of the invention: a sea platform based on a board elongated platform which is intended for the following purposes:
Security and Protection,
Navigation and Detection,
Tracking and Monitoring location from a distance
Coverage sharing,
Safety,
Search, rescue and extraction,
Weather forecasting
Sea mapping,
Detailed real-time updates,
Moreover: fun and enjoyment as an ancillary product.

The main target of the present invention is to Equip the users: Commercial & private consumers (for example: Fisherman, surfers, Offshore policemen, Lifeguard, Surfer) with the necessary measures, resources and existential equipment-in order to Improve the survivability percentage. This information is also essential for assessing and alerting natural disasters - such as a tsunami.

It is the object of the present invention to describe a product that is:
A board-based on a board elongated platform used in water-based activities that are lightweight but are strong enough to support an individual.
Is based on Civilian, Non-military off the Shelf-products.
Contains complete System Integration & Packaging.
Is a part of a structured, built-in and integral sea-based platform.
Can be customized according to the customer’s specification and requirements.

The S.O.S.ea (Save Our Souls over Sea) product could alternatively be configured several platforms such as:
Wind-surfing Board
Surfboard
Jet Sky & surfboat
Canoe Boat
Inflatable lifeboat
kite surfing board
paddleboard or Stand up paddleboard (SUP).

In some embodiments, the system of the platform is based on communication with a Drone as sub-system communicating with the platform (or any other S.O.S.ea based platform) or/and far away central monitoring ruggedized laptop computer under the Oversight (Over-Sea-Sight) interconnected network.

It is the object of the present invention to describe the S.O.S.ea product, based on a board or other very shallow water vessel, such as a surfboard, a paddleboard, a S.U.P., a wind-surfboard or a kite-surfboard, comprising: 1. A plurality of sensor systems/sub-systems using data share in any form of communication:
a. Environmental, Meteorological and forecasting observations by sophisticated sensors - sensors that detect and record the environmental and/or surrounding conditions data in built-in and integrated computer readable memory (CRM), mainly solid-state non-volatile computer memory, such as solid-state drive (SSD), Random-access memory (RAM) or FLASH memory, and/or download the data to another unit of the board (such as the data unit) or an external system (such as a computer) in order to enable further processing and analysis of the data or/and share it using any form of communication:
   i. Water sensor, configured to detect various properties of the water, such as temperature, quality, salinity, chemical properties, pH sensor and toxins, in addition to other known technologies.
   ii. Meteorological elements: wind direction and speed, pressure, temperature and humidity.
   iii. Area mapping using Sound Navigation And Ranging (Sonar): implanted and integrated in any possible optimal but logical location to the high-tech surfboard or any other Relatively light sea platform and configured to record the underwater volume, size, shape of items, total mass (and more important and/or share it using any form of communication) such as:
      1. Shape and/or depth and/or speed of unidentified surrounding objects around the user.
      2. Surrounding Identification of Sea life big/small detection with alarm notification such as Sharks, Seals, sea Snakes, Jellyfish and Stingrays, fish or whales,
      3. Detection sea underwater terrain of large and jagged objects such as
      a. Hidden beaches, protected by natural or artificial bays, Piers, Marinas and breakwaters, iceberg, rocks and buoys.
      b. Unidentified and suspicious objects: rock reef, coral.
      c. Pollution and industrial (fishing) equipment, such as hooks, various types of nets and other objects.
      d. Auto or manual Depth Range reading and bottom contour indicator
      The sonar system also enables the tracking of changes in the ocean floor, enabling the identification of changes caused by geological or meteorological events.
   iv. Meteorological sensor system that function as an Advanced Real-time Warning & alert system, Early prediction of extremes storm system shifting (such as wind speed and position, atmospheric temperature, atmospheric humidity, atmospheric pressure, barometer, wave conditions). If the S.O.S.ea product consists of a rig (such as in the case of a wind-surfboard), some of the Meteorological sensors may be imbedded the rig (such as the mast or handle).
   v. Visual/optical detector/sensor, such as a camera, IR spectrophotometer, UV spectrophotometer. In some embodiments, the camera is configured with a wavelength filter, such as IR or UV filter. The optical system could be directed to the user, above or below the water. In some embodiments the camera is configured as an Endoscope. In some embodiments, the camera has an optional light source, such as an LED. In some embodiments, the sensor is time or motion activated. The sensor is water and salt resistant.
   vi. Audio sensor, such as a microphone or an audio recording system. The microphone could be directed above or under the water. The microphone is water and salt resistant. In some embodiments, the sensor is time or motion activated.
b. Platform sensors - sensors that detect and record the actions and status of the sea platform to ensure you won’t be cut off from the rest of the world:
   i. Radio, radar and/or satellite-based tracking system, such as Radio-navigation-satellite service (RNSS), mainly the Global positioning system (GPS). In some embodiments, the system comprises an interactive SOS trigger to the 24/7 search and rescue monitoring center, sending and receiving (inReach) messages.
   ii. Movement or motion sensor, enabling the changes in the speed and/or direction of the S.O.S.ea board. The sensor could be based on technologies such as an accelerometer and other known technologies.
c. User sensors (regarding the actions and status of the user of the S.O.S.ea:
   i. User sensor, for the detection of the position and/or status of the user. The sensor could be configured for the detection the position of the user (such as a contact sensor) or of the user’s status (such as a heartbeat, pulse, body temperature and other known technologies). The user detector could be configured as part of the body (such as the floor) of the S.O.S.ea board, preferably in the area where the user stands. If S.O.S.ea consists of a rig (such as in the case of a wind-surfboard), some of the sensors may be imbedded in the handle. If the system comprises a paddle, some of the sensors may be embedded in the paddle handle or as an integral part of the Astrodeck surfboard that is integrated into the surfboard body and/or on the surfboard itself.
   ii. In some embodiments the S.O.S.ea board is connected to the user by a leg and/or hand/wrist or ankle band. The band could comprise additional user sensor (such as pulse, blood pressure, body temperature). The band can also serve as a controller or alarm, so as to alert the user about changes in the environment.

The sensor system is configured to save the data in built-in and integrated computer readable memory (CRM), mainly solid-state non-volatile computer memory, such as solid-state drive (SSD), Random-access memory (RAM) or FLASH memory, and/or download the data to another unit of the board (such as the data unit) or an external system (such as a computer) in order to enable further processing and analysis of the data or/and share it using any form of communication.

The sensor system could be interconnected by wired or wireless technologies, so as to create a personal area network (PAN) to enable the transferring of the recorded data. The wireless technologies could be a wireless personal area network (WPAN) based on a technologies or protocol such as IEEE 802.15, Bluetooth, Wireless USB, ZigBee and other known technologies. In some embodiments the S.O.S.ea system, creates a wireless ad hoc network (WANET) or Mobile ad hoc network (MANET).

II. network connectivity systems (such as InReach):
a. Warning and emergency response system - means for an alert or beacon. The beacon can alert the user or other people about hazards:
   i. Physical: a system for emitting a physical alert, such as a noise/sound or a light. This system would be preferable for alerting the close proximity or general area of the user.
   ii. Electronic: a system for emitting electronic alert based on a telecommunication technology, such as a telecommunication system-based signal (such as the cellular network) or a local network-based beacon (such as Bluetooth). This system would be preferable for people in the area of the user (such as via a Bluetooth beacon) or those far away from the (such as over cellular platform). In some embodiments, the signal encodes the position and status of the user, as logged by the sensor (user, S.O.S.ea board or any other relatively light sea platform and/or environmental).
      In some embodiments the system is configured to detect the position of the S.O.S.ea board and/or user, and identify the optimal technology (or technologies) for alerting other parties, such as emergency organizations.
b. First aid kit: comprising item for the treating of the user in case of an accident.

III. Data unit (DU), configured to receive, log/store and organize the data the data logged by the sensors. In some embodiments the DU is configured to transmit the data to the communication unit. The DU comprises a computer readable memory (CRM), mainly solid-state non-volatile computer memory, such as solid-state drive (SSD), Random-access memory (RAM) or FLASH memory.

IV. Communication Unit (CU), configured to transmit the data logged from the sensors. The CU may operate via various communication platforms/technologies, depending on the position of the S.O.S.ea board (such as the distance from shore). These technologies could be WIFI, radio, cellular or satellite based. In some embodiments the system creates a wireless ad hoc network (WANET) or Mobile ad hoc network (MANET) with the CU of other S.O.S.ea systems that are in the vicinity.

V. In some embodiments, the S.O.S.ea board, additionally comprises additional units, such as:
a. A processer unit (PU) - configured to receive the data from the data unit and send and/or receive data via the communication unit. The processor could be operated by android, IOS, Unix/Linux or Windows based operating system. The processor could be based on an architecture and/or technology such as those used by Intel, QUALCOMM, MediaTek, Broadcom, AMD, NXP or Samsung. In some embodiments, the processor is configured to accept additional applications or programs. In some embodiments, the PU additionally comprises an integrated computer readable memory (CRM), mainly solid-state non-volatile computer memory, such as solid-state drive (SSD), random-access memory (RAM) or FLASH memory.
b. Display unit (DsU) - in some embodiments the data unit is configured to display the data on a screen. The screen could be built into the S.O.S.ea board or the rig. The display could be based on light emitting diode (LED), electroluminescent Displays (ELD), liquid crystal display (LCD) or organic LED (QLED) technology. In some embodiments the screen is a touch screen. The screen would be water and salt proof, so at to be used in various bodies of water.

In some embodiments, some or all of the CU, PU and DU are configured in one unit, such as a printed circuit board (PCB) of a cellular phone or tablet. In some embodiments, the CU, PU, DU and DsU are configured as a separated sub systems as an individual (shop) replaceable units (SRU) that have to be integrated and combine to a one S.O.S.ea system product inherent and built-in a board or any other Relatively light sea platform.

In one embodiment, the S.O.S.ea board comprises a power source, such as a battery. In some embodiments the battery is rechargeable, configured to be removed or to be charge in-place via a waterproof docking station. In some embodiments, the board comprises a charging system that is activated by environmental conditions, such as a solar/photovoltaic-panel or a turbine activated by wind or water. In some embodiments, the battery could be charged by the user’s actions, such as a hand crank, in some embodiments, the board comprises a wireless charging system.

The S.O.S.ea product, must be light and strong as well as buoyant and maneuverable and therefore are typically constructed of a lightweight material, such as polyurethane (PU), polystyrene (PS) foam or expanded polystyrene (EPS) or any combination thereof covered with layers of fiberglass cloth, and polyester or epoxy resin. In some embodiments the platform is an inflatable craft. Wind-surf board additionally comprises a rig, connected to the board by a free-rotating universal joint and consisting of a mast, boom and sail.

The CU of S.O.S.ea is configured to connect to a cloud-based data base via various communication platforms/technologies, depending on the placement/position/distance of the S.O.S.ea board (such as the distance from shore). These technologies could be WIFI, cellular or satellite based. In all cases, the technologies could be enclosed in water-proof encasement.

In some embodiment, the S.O.S.ea board is connected to an external system, such as a computer, a server or a cloud-based data base (CBDB), configured to receive and store the data from multiple users or S.O.S.ea products. The CBDB is configured to organize and analyze the data, so as to:
Identify and recommend optimal water conditions (such as the best waves or winds). In some embodiments, the recommendations could be based on the users
Identify dangerous or unsafe water conditions.
Notify interested parties regarding the user status and/or oceans/water conditions (such as emergency organizations, navy, costal patrol, lifeguards, surfers, fishermen and any other surround enclose users).

In some embodiments, the data and analysis can be presented or accessed via an external device, such as a web page or a mobile application.

In some embodiments, the CU is additionally configured to communicate with a maned or unmanned vehicle. The vehicle could be an aerial or “flying” platform (in particular a rotor based system, such as a quadcopter Multirotor or multicopter drone) or water borne (such as a submarine).

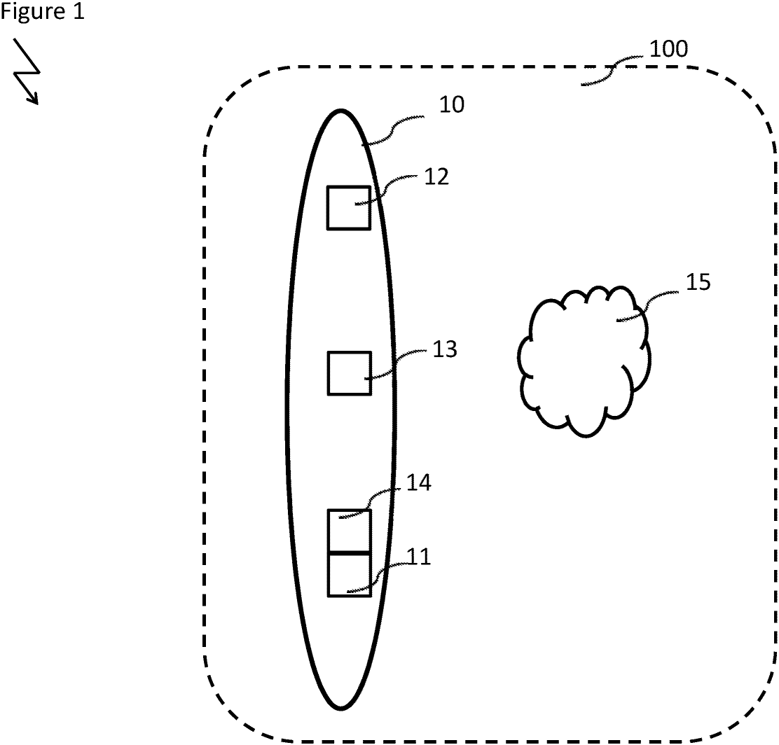

Reference is made to FIG. 1, presenting the schematic representation of a system 100, with an Autonomous inert, modular & built-in (inReach) communication system 10 comprising a combined data unit, processor unit and communication unit 11, interconnected to a safety unit 14 and a plurality of sensor units 12 (environmental) 13 (user sensors). The communication unit is connected by various wireless technologies to a cloud-based data base 15.

### EXAMPLES

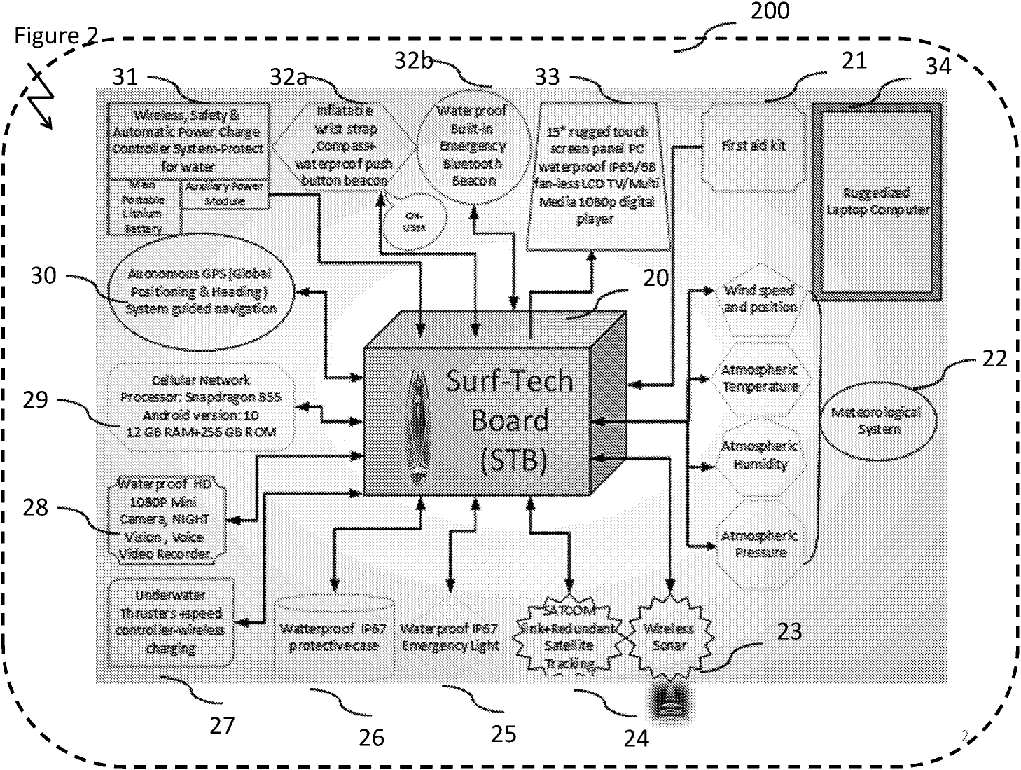

Example #1: Reference is made to FIG. 2, showing example 1, demonstrating an embodiment of a High-tech surfboard based-system as a S.O.S.ea one preferable product, which presenting a wide variety of implementing configurations options according to the inventor definition and specifications and/or user-customer requirements needs 20, comprising:
first kit 21
meteorological system 22, with sensors for:
   o wind speed and position,
   o atmospheric temperature,
   o atmospheric humidity,
   o atmospheric pressure.
Wireless sonar 23.
SATCOM link + satellite tracking 24.
Waterproof IP67 emergency light 25.
Waterproof IP67 protective case 26.
Underwater thruster + speed controller wireless charging 27.
Waterproof HD 1080P mini camera, night vision, voice/video recorder 28.
Waterproof IP68 mobile phone dual-sim-network QUALCOMM processor, android version 10, 12 GB ram + 256 GB ROM 29.
Autonomous GPS system guided navigation 30.
Wireless safety and automatic power charge control system-product for water 31:
   Main portable lithium battery.
   Auxiliary power module.
Inflatable wrist strap with a compass 32a (on/connected to user) and beacon button 32b
15-inch rugged touch screen panel PC, waterproof IP65/68, fan-less LCD TV or multimedia 1080p digital player 33.
The system is linked to a ruggedized laptop computer 34.

In this example, S.O.S.ea enables the continuous and real-time tracking of the user’s actions and to emit an alert in case of an emergency. When the users returns, the recorded data is uploaded to the computer or a cloud-based database to store, analyze and present the user data.

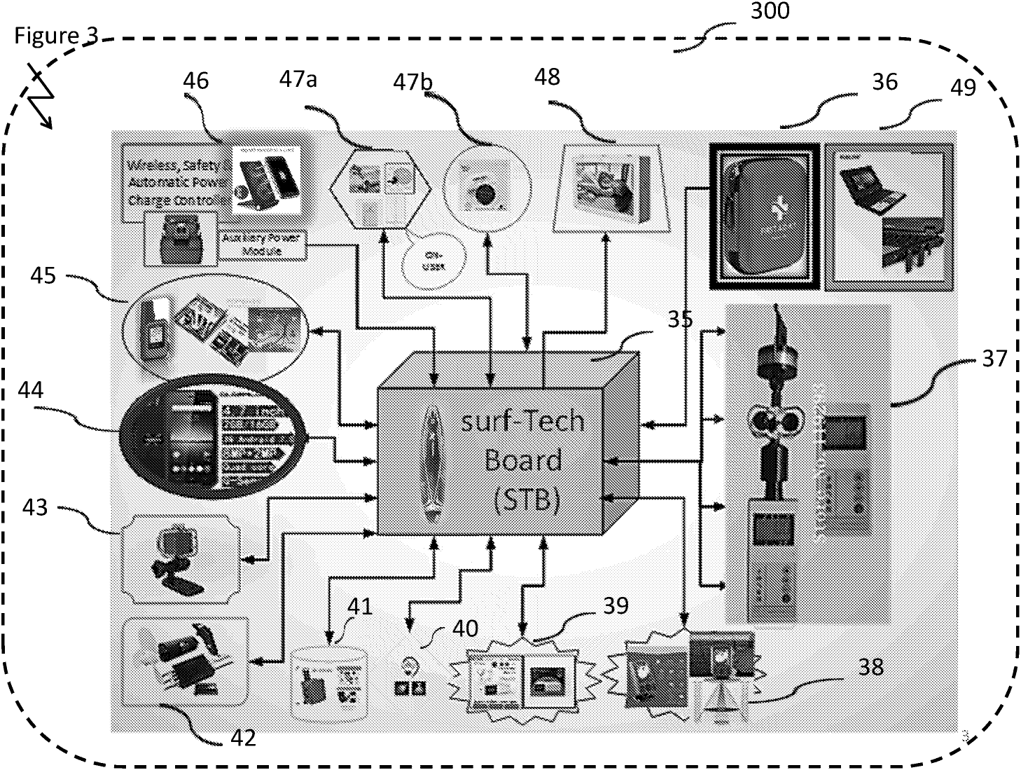

Example #2: Reference is made to FIG. 3, showing example 2, demonstrating an embodiment of the High-tech surfboard system 300, comprising of:
A sport board 35 comprising:
   first kit 35
   meteorological system 36,
   Wireless sonar 38.
   SATCOM ink + satellite tracking 39.
   Waterproof p67 emergency light 40.
   Rugged, impact resistant and Waterproof protective case, rated IP67 or above 41.
   Underwater thruster + speed controller wireless charging 42.
   Waterproof HD 1080P mini camera with night vision and voice/video recorder 43.
   Waterproof IP68 mobile phone dual-sim-network QUALCOMM processor, android version 10, 12GB ram + 256 GB ROM 44.
   Autonomous GPS system guided navigation, 100% global satellite coverage, 2-way messaging & global interactive SOS, Tracking and location sharing, cloud storage, 45.
   Wireless safety and automatic power charge control system-product for water 46.
   Inflatable strap with a compass 47a (on/connected to user) and beacon button and a Life jacket rescue boating drifting surfing life Vest with built-in sub systems and sensors 47b
   15-inch rugged touch screen panel PC, waterproof IP65/68, fan-less LCD TV or multi-media 1080p digital player 48.
The system is linked to a ruggedized laptop computer 49.

In this example, S.O.S.ea system enables the continuous and real-time tracking of the user’s actions and to emit an alert in case of an emergency. When the users return, the recorded data is uploaded to the company Data Base over RT communication.

Example #3: Extraction and Rescue for safety reasons:

A surfer is washed-out by a large wave. An ankle-based sensor identifies that the user has been knocked out and an emergency alert is sent out over the cellular network. A lifeguard with a fully equipped and activated S.O.S.ea board (such as a S.U.P. based system) is alerted. The onboard system receives the data regarding the position of the surfer and directs the lifeguard to the surfer by the fastest and safest route possible.

Example #4 HTSB Block Diagram:

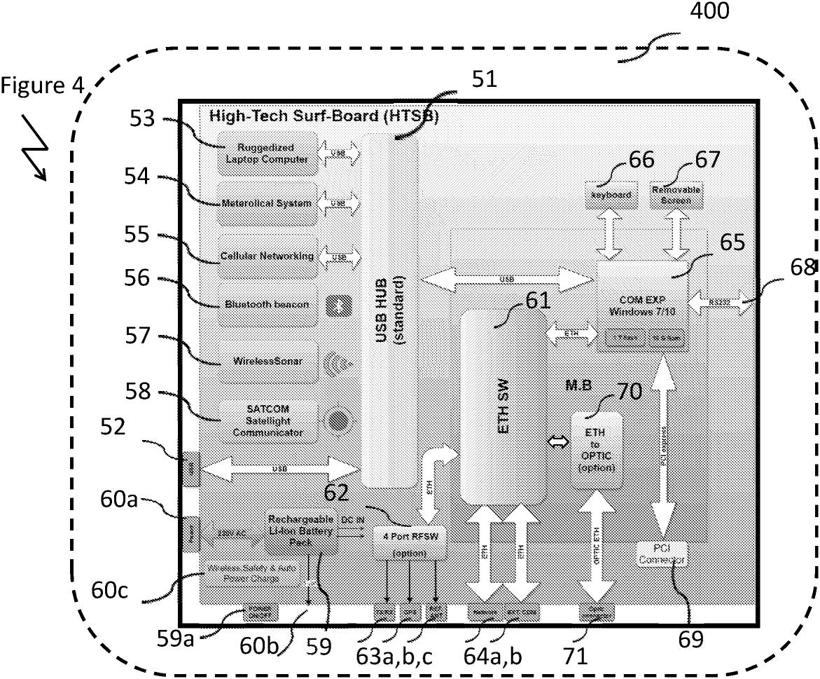

Reference is made to FIG. 4, presenting a one example connectivity of many others optional arrays and structures that can be applied in the present invention. The system is based around a Universal Serial Bus (USB) hub 51 that has a plurality of USB receptacles (socket) 52, that is/can be connected to a number of systems: a (ruggedized) laptop computer 53, a meteorological system 54, cellular networking system 55, Bluetooth beacon 56, wireless sonar 57, SATCOM Satellite Communicator 58. The board system has a rechargeable Li-Ion battery pack 59 that can power the system, connected to an on/off power switch 59a, with 220 AC 60a, 5 volt 60b and wireless power charge stations 60c.

The M.B. (mother board) unit/segment comprises an Ethernet switch (ETH SW) unit 64 connected via Ethernet (ETH) to a RFSW 4-port 62 (optional) that can be connected to other (external) units such as multiple-input and multiple-output Transmitter/Receiver (TX/RX) 63a, GPS 63b, and Radio-frequency Antenna (RF-ANT) 63c and the network 64a and EXT.com 64b. The windows based COM EXP (COM EXPRESS: PCB with computer on windows capability) 65, comprising a CRM (16 GB RAM and 1 TB Flash), is connected via:
USB to the USB hub 51 and external display input systems, Keyboard 66 and display screen 67);
ETH (Ethernet) to the ETH SW 61;
RS232 standard for serial communication data transmission 68;
Peripheral Component Interconnect Express (PCI-e) to a PCI connector 69;
Optic connection option to a ETH to OPTIC converter 70, with an optic connector 71;

This system can be constructed using the following components:
1. Phiradar FF688W-BG Wireless 800 M Sonar Fish Finder Fishing Baitboat Echo Sounder Color LCD Remote Control
2. Kinco MT4434T MT4434TE HMI Touch Screen 7 inch 800*480 Ethernet 1 USB Host new Human Machine Interface
3. ETH-MPI MPI / DP to Ethernet Optical Isolated Programming Module for Siemens S7-300 USB-MPI CP343-1 CP5611 STEP7 TIA Portal
4. Narda S123D 2-18 GHZ SPDT RF microwave semiconductor switch 12 V SMA
5. RJ45 To VGA Extender Female To LAN CAT⅚ RJ45 Network Ethernet Cable Female Adapter Computer Extra Switch Converter
6. 9 Pin DB9 COM Serial RS232 to RJ45 Cat5 Ethernet LAN Console Cable Switch Line For Routers wholesale cheap
7. Mini 3 Port HDMI Splitter Adapter Cable 1.4b 4K*2K 1080P Switcher HDMI Switch 3 in 1 out Port Hub for HDTV Xbox PS3
8. LS-S5500V2-48P-WiNet48 port Gigabit intelligent network management switch 4 Gigabit
9. USB C Hub to HDMI Thunderbolt 3 Adapter with Type-c PD TF SD Reader Slot for MacBook Pro/Air 2019 100pieces/lot
10. 10FT Network Switch 8-port EIA-232 Async Cable HD8 Cable CAB-HD8-ASYNC Cable
11. Black 4 Port Micro USB Power Charging OTG HUB Cable For Smartphone tablet pc
12. Practical First Aid Kit Waterproof Medical Bag For Hiking Camping Bike Car Travel Outdoor Rescue Treatment Survival Kit
13. Naturehike Surf Leash Sup Surfing Surfboard Leash Sup Leash Rope Stand Up Paddle Board Leash Coil Accessories
14. Survival Camping Emergency Empty Bag Tactical Medical First Aid Kit Military Waist Pack Travel Tactical Pouch
15. Stainless firestarter Outdoor Camping Hiking Survival Flint Portable Keychain Match Lighter Emergency Survival tool Fire Starter
16. Portable Aluminum Safety Whistle Double Lifesaving Emergency SOS Outdoor Survival Whistle Tactical Emergent Survival Equipment
17. Portable Aluminum Safety Whistle Double Lifesaving Emergency SOS Outdoor Survival Whistle Tactical Emergent Survival Equipment
18. Outdoor Multifunctional Survival Bracelet Paracord Braided Rope Men Camping EDC Tool Emergency SOS LED Light Compass Whistle
19. Military Emergency Braided Survival Bracelet With SOS LED Paracord Outdoor Camping Rescue Rope Bangles Compass Whistle Knife
20. Multi-function Survival paracord 4 mm bracelet with led light reflective paracord bracelet camping hiking rescue 550 paracord
21. 8.0 mm Endoscope Camera 1080P HD USB Endoscope with 8 LED 1/2/5M Cable Waterproof Inspection Borescope for Android PC
22. Garmin Fenix 3/5 Gray Fly-3 hr sapphire mirror men’s photoelectric heart rate multifunctional outdoor sports watch riding smart
23. 50000 mAh Power Bank TypeC Micro USB QC Fast Charging Powerbank LED Display Portable External Battery Charger
24. Endoscope 1080P HD Borescope 8 mm Inspection Snake Camera with 4.3 inch Display Screen 8 LED Lights for Car Pipe
25. Electric propeller SUP surfboard thrusters electric jet fins Latest patented products Marine propeller electric motor fin 2800 W
26. GNSS board GNSS antenna USB to TTL ZED-F9P module RTK high-precision gps antenna GNSS receiver base and rove TOPGNSS TOP906
27. Waterproof tool case toolbox trolley Sealed Photographic shipping Instrument camera case with pre-cut foam
28. YONSUB Neoprene Life Jacket Vest Men Fishing Life Jacket Rescue Boating Drifting Surfing Life Vest Water Sports Man Jacket
29. 15 inch industrial rugged touch screen panel pc waterproof IP65 fan-less LCD display all in one pc
30. [BELLA]YGY-QXY handheld weather / meteorological instrument / meteorology Table / Portable 5 meter meteorological elements
31. BD982 oriented GNSS RTK high precision card board module, GPS, GLONASS, BEI DOU, GALILEO
32. Lucky FFW718 Depth Sonar Fish Finder Wireless Sounder for Fishing Echo Alarm Fishfinder 100 M Depth River Transducer Sensor
33. 200 m distance Bluetooth beacon 210L for indoor locationing
34. ZigBee/Z-wave temperature and humidity sensor, 433 MHz freeze and temperature alarm
35. Cyboris Sports Earphone Waterproof 16 GB Mp3 Player Bluetooth Headset 12 Hrs Play time Running IPX7 Hifi Bass Wireless Earbud
36. 10 inch Tablet PC Android 9.0 Octa Core 8 GB RAM 128 GB ROM 8.0MP GPS WiFi FM 3G 4G FDD LTE tablet 10 10.1
37. 7′5″ surfboard (surf longboard)
38. 2 M 1 M 5.5 mm 7 mm Endoscope Camera Flexible IP67 Waterproof Inspection Borescope Camera for Android PC Notebook 6LEDs Adjustable
39. Original Garmin VIRB Ultra 30 GPS Outdoor Micro Smart Sports HD Camera Waterproof 4 K Sports camera
40. Dual Camera Mount Headlight Holder Computer Mount For GARMIN WAHOO Elemnt Bolt Cateye GIANT Computers Adjustable Mount
41. Tablet Shockproof Heavy Duty With Stand Hang Case For Samsung Galaxy Tab A A6 10.1 2016 T580 T585 SM-T585 T580N Cover Funda +pen
42. Tablet Pc 10.1 inch Android 9.0 Tablets 8 GB+128 GB Ten Core 3 g 4 g LTE Phone Call IPS pc Tablet WiFi GPS 10 inch Tablets
43. Wearable Nordic Tag Beacon Solution Tx Rx Ble4.0 Low Energy Ble Programmable Bluetooth Module Price
44. DHL NEW IP67 3 W 5 W COB Waterproof LED Underground Light Outdoor Ground Garden Path Floor Buried Yard Spot 85-265 V DC12 V
45. Waterproof trolley case toolbox tool Dustproof Protective box Camera Case Instrument box equipment box with pre-cut foam lining
46. RUGLINE RX11 Second Webcam Camera 11.6 Inch Laptop Rugged Tablet PC Windows 10 Home OS 8 GB 128 GB
47. Industrial High Power PWM DC Motor Speed Controller 12 V 24 V 36 V 48 V 4000 W DC Motor Speed Regulator
48. Outdoor 37 50 55 65 70 98 inch wall mounted led lcd tft hd waterproof TV Advertising Multi Media 1080p digital signage player
49. DHL S20W 4 K WIFI Outdoor Sport Action Camera 170 Degrees 1080P UHD Bicycle Cycling Helmet 10 M Waterproof Mini Sport DV Camera
50. SQ12 30 M Waterproof HD 1080P Mini Camera Night Vision Sport DV Voice Video Recorder Action Camera Dashcam VS SQ11
51. MI70E 300 m underwater azimuth thruster with built-in controller 6.5 KG ROV RC boat submarine POD DC24V BLDC motor direct drive
52. Waterproof Card beacon with push button iBeacon & Eddystone supported
53. MI50 underwater 200 m 5 kg azimuth thruster POD ROV submarine RC boats anticorrosion 6S 24 V 360 W 5 KG thrust BLDC brushless motor
54. 12 AH Electric Surfboard Battery Portable Lithium Battery Safety Automatic Charge Protect For Water Surfing Sports Equipment Part
55. Maytech Fully waterproof Efoil kit electric hydrofoil surfboard kit 65162 motor 300A ESC and waterproof remote
56. Rocket 5682 910 KV 4200 W RC Brushless Motor w/ 56-S Water Cooling Jacket Set for Surfboard 1.5 m (or Above) RC Boat
57. Inflatable Wrist Strap Wearable Wristband Water Safet Wrist Life Buoy Escape Lifesaving Wristband Self Rescue Bracelet
58. X96 TV Box for Streaming Media Player for Amlogic S905X IPTV Suppor HEVC 4 K WiFi Sport Movie Music Service 2 GB/16 GB
59. Zgemma star H7S E2 Linux Satellite Cable Linux Operating System Satellite Receiver HD2.0
60. wearable bracelet ibeacon for kids protection
61. BD982 oriented GNSS RTK high precision card board module, GPS, GLONASS, BEI DOU, GALILEO
62. Survival Camping Emergency Empty Bag Tactical Medical First Aid Kit Military Waist Pack Travel Tactical Pouch
63. 10 In 1 Survival Kit Set Outdoor Tourism Multifunction First Aid Sos Edc Emergency Self Defense For Survival Box

1. A water activity board, comprising:
a. a plurality of sensors;
b. a data unit interconnected to said sensors; and
c. a communication unit interconnected to said data unit;
wherein said communication unit is configured to communicate to a cloud-based database.

2. The board of claim 1, wherein said sensors are selected from a group consisting of Environmental sensors, sea platform sensors and User sensors.

3. The board of claim 2, wherein said environmental sensors are selected from a group consisting of water sensors, sonar, meteorological sensors and visual/optical detector.

4. The board of claim 3, wherein said water sensors are selected from a group consisting of sensor for the detection of temperature, chemicals, pH, toxins, salinity.

5. The board of claim 3, wherein said water sensors are selected from a group consisting of sensor for the detection of wind speed, wind direction, atmospheric temperature, atmospheric humidity and atmospheric pressure.

6. The board of claim 3, wherein said visual/optical sensors are selected from a group consisting of cameras, UV spectrophotometer, IR spectrophotometer.

7. The board of claim 2, wherein said board sensors are selected from a group consisting of global positioning system (GPS), satellite tracking system and movement/motion sensor.

8. The board of claim 2, wherein said user sensors are selected from a group consisting of Pressure sensor, heartbeat sensor, heat sensor and blood pressure sensor.

9. The board of claim 2, wherein said user sensors are configured as part of the body, floor, rig and/or handle of said board.

10. The board of claim 2, wherein said user sensors are connected to said user by a hand, arm, wrist or ankle band.

11. The board of claim 2, wherein said user sensors are configured to detection the position, actions and/or status of said user.

12. The board of claim 1, wherein said sensors are configured to transmit generated data to said data unit.

13. The board of claim 1, wherein said data unit is configured to store and/or log data received from said sensors.

14. The board of claim 13, wherein said data unit comprises a unit characterized as transitory memory, computer-readable memory.

15. The board of claim 1, additionally comprising a processor, interconnected to said data unit and said communication unit.

16. The board of claim 15, wherein said processor is configured to perform at least one action selected from:
a. to receive data from said sensors;
b. to receive data from said data loggers;
c. to transmit said data via said communication unit;
d. to control the operation of said sensors.

17. The board of claim 1 or claim 15, wherein said communication unit is configured to transmit data from said data unit or said processor.

18. The board of claim 1, wherein said communication unit is configured to communicate using at least one technologies selected from a consisting of radio and electromagnetic waves.

19. The board of claim 18, wherein said communication unit is configured to communicate used a protocol selected from a group consisting of Bluetooth, wireless, cellular.

20. The board of claim 1, wherein said components are interconnected by technologies selected from a group consisting of wired and wireless technologies.

21. The board of claim 1, wherein said components are configured to create:
a. a wired or wireless local area network (WLAN);
b. a wired or wireless personal area network (WPAN);
c. a low-power wide-area network (LPWAN);
d. a wireless sensor network (WSN).

22. The board of claim 1, wherein said in particular sport board is configured as a surf board, a wind-surf board, paddleboard, standup paddleboard or a kite-surfing board.

23. The board of claim 1, additionally comprising a safety system, selected from a group consisting of means for an alert and a first aid kit.

24. The board of claim 23, wherein said means for alert is selected from a group consisting of physical means and electronic means.

25. The board of claim 24, wherein said physical means for alert is selected from a group consisting of noise, sound and light.

26. The board of claim 24, wherein said electronic means for alert is based on an electromagnetic technology selected from a group consisting a cellular signal, a Bluetooth beacon.

27. The board of claim 24, wherein said electronic means is configured to generate/emit a signal encoding user data, said data selected from a group consisting of user position, user status.

28. The board of claim 1, additionally comprising a power source, wherein said source is characterized as a battery.

29. The board of claim 28, wherein said battery is a rechargeable.

30. The board of claim 29, additionally comprising a charging unit configured to charge said battery from a source selected from a group consisting of wind power, water power, solar energy and user actions.

31. The board of claim 28, wherein said battery is replaceable.

32. The board) of claim 1, additionally comprising a display, said display configured to present the data from said sensors.

33. The board of claim 1, wherein said components are characterized as waterproof, IP65 or higher.

34. An autonomous communication system, comprising:
a. the board system of claim 1; and
b. a cloud-based data base (CBDB);
wherein said communication system is configured to communicate with said cloud-based data base.

35. The system of claim 34, wherein said CBDB is characterized by at least one of the following:
a. configured to receive data from said communication system;
b. configured to store data from said communication systems;
c. configured to analyze said data;
d. configured to present said data from said communication system;
e. configured to present analysis from said data base.

36. The system of claim 34, wherein said CBDB is configured to generate an alert regarding emergencies, hazards or other safety issues.

37. The system of claim 34, additionally comprising a maned or unmanned vehicle.

38. The system of claim 37, wherein said vehicle is a drone.

39. A method of participating is water sports, comprising steps of:
a. obtaining the board of claim 1;
b. activating the systems of said board;
c. using board;
wherein said board comprises sensors, configured to collect data characterized as environmental data, board data or user data.

40. A method of evaluating the safety of a user, comprising steps of:
a. obtaining the board of claim 1;
b. activating the systems of said board;
c. using said board;
d. analyzing the data of said sensors; and
e. presenting data and analysis of said data;
wherein said data is collected from at least one sensor on said board.

41. The method of claim 40, additionally comprising a step of transferring said data to a cloud based data base.

42. The method of claim 40, additionally comprising a step of identifying hazardous or unsafe conditions.

43. The method of claim 40, additionally comprises a step of identifying changes in the status of the user.

44. The method of claim 42 or claim 43, additionally comprising a step of generating an emergency alert.
